(19) United States
(12) Patent Application Publication
(10) Pub. No.: US 2008/0163107 A1
(43) Pub. Date: Jul. 3, 2008

(54) METHOD AND SYSTEM FOR ORGANIZING MULTIPLE USER INTERFACES ON A DISPLAY SCREEN

(76) Inventor: Tobias HAUG, Heidelberg (DE)

Correspondence Address: KENYON & KENYON LLP, 1500 K STREET N.W., WASHINGTON, DC, 20005, US

(21) Appl. No.: 11/618,758

(22) Filed: Dec. 30, 2006

(51) Int. Cl. G06F 3/048

(52) U.S. Cl. 715/804

(57) ABSTRACT

A method and system are provided for organizing multiple user interfaces. At least two files are opened for at least one application. Information from the first user interface file is recorded into a temporary buffer. Information from the second user interface file is recorded into a temporary buffer. A differential analysis may be then conducted of the first and second temporary buffers. If the differential analysis indicates no common term then each file will have its own respective group name. If the differential analysis indicates at least one common term, then the first and second files are appointed the same group name so that when minimized on a display screen, the first and second files are represented under their group name button.

### FIELD OF THE INVENTION

The present invention relates to a system and method for organizing multiple user interfaces on a display screen.

### BACKGROUND

Graphical user interfaces, such as a window, are commonly used by software applications to display and receive information to and from a user. The graphical user interface may represent data as a graphical object that can be selected and modified by a computers pointing device.

Multiple graphical user interfaces from multiple applications may be open on a computer. Given the amount of open user interfaces, a user may wish to minimize any user interfaces not being actively used. Such minimization may be a button located at the bottom of the display screen. Upon clicking the button, the user interface may be maximized on the screen for use. The button may indicate the associated application. When two or more user interfaces from the same application are minimized, the two or more user interfaces may be represented by the same button located at the bottom of the display screen. The button may indicate the number of user interfaces for that application it represents. For example, if two user interfaces of the same internet browser (“BrowserA”) are minimized, they may be represented by a button at the bottom of the display screen entitled “BrowserA (2).” The application name is identified, and the number of user interfaces represented by the button are minimized. Further, when a user clicks on the button, the user may be provided with a drop list which indicates each user interface open, and may allow the user to select an interface to maximize.

In situations where a user uses an application for multiple purposes, e.g., for online shopping via an internet browser application, the user may minimize the multiple user interfaces. However, the user may then be presented with one button indicating that application and the number of the interfaces represented. Such situations are not convenient nor useful for a user when navigating between different user interfaces concerning multiple subjects. Accordingly, there is a need in the an for an improved user interface minimization option.

### BRIEF DESCRIPTION OF THE DRAWINGS

FIG. 1 illustrates an example display screen having multiple user interfaces minimized according to an embodiment of the present invention.

FIG. 2 illustrates an example display screen having a user interface according to an embodiment of the present invention.

FIG. 3 illustrates an example display screen having a user interface according to an embodiment of the present invention.

FIG. 4 illustrates an example lookup table for determining groupings of user interfaces according to an embodiment of the present invention.

FIG. 5 is a flowchart involving multiple files of an application according to an embodiment of the present invention.

FIG. 6 is a flowchart involving multiple applications according to an embodiment of the present invention.

FIG. 7 is a flowchart involving an application having a search engine according to an embodiment of the present invention.

### DETAILED DESCRIPTION

Embodiments of the present invention provide a system and method for organizing user interfaces on a display screen. Further, embodiments of the present invention provide a system and method for organizing user interfaces in minimized form on a display screen.

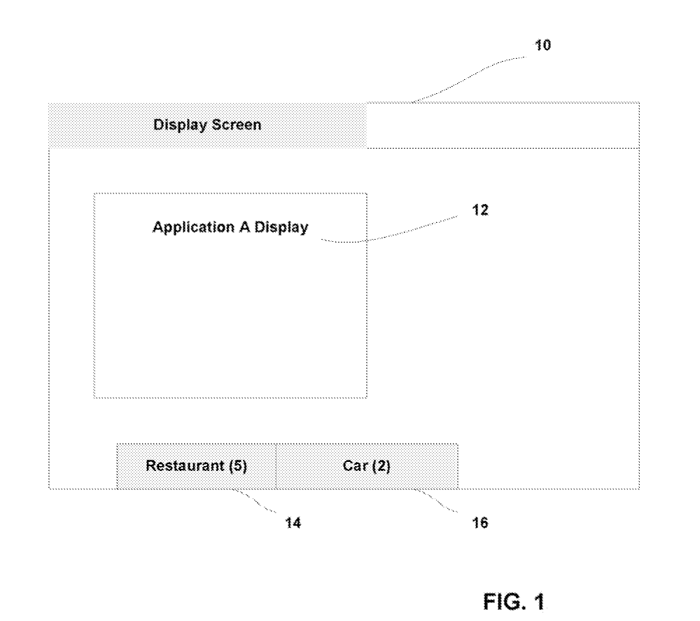

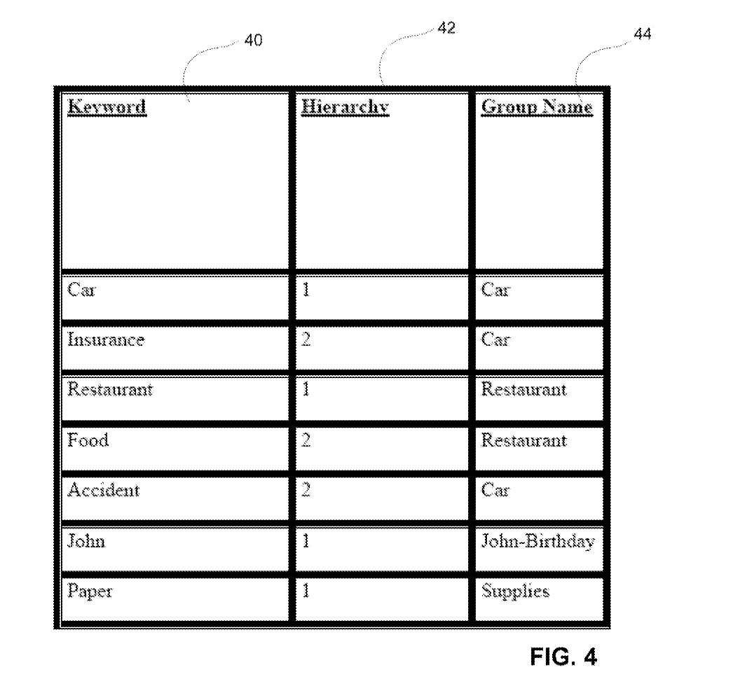

FIG. 1 illustrates an example display screen having multiple user interfaces minimized according to an embodiment of the present invention. In FIG. 1, the display screen 10 has an application A 12 display. Files for application A 12 have been opened, including those which are under the group name restaurants 14, and under the group name car 16. The restaurants 14 tab indicates that five (5) application files are within the group name restaurants. The car 16 tab indicates that two (2) application files are within the group name restaurants. It may be appreciated that the application files can be grouped in a number of ways. First, a user may be requested for input via a popup window or other user interface to name a group for each file. Second, a first word or even any or all words in the title of the file may be grabbed and used as a group name for a file. Third, any search terms copies from a user's input in a search interface may be grabbed and used as a group name or used as a means to assign a group name. For example, a predefined list of group names may be used. See, e.g., FIG. 4.

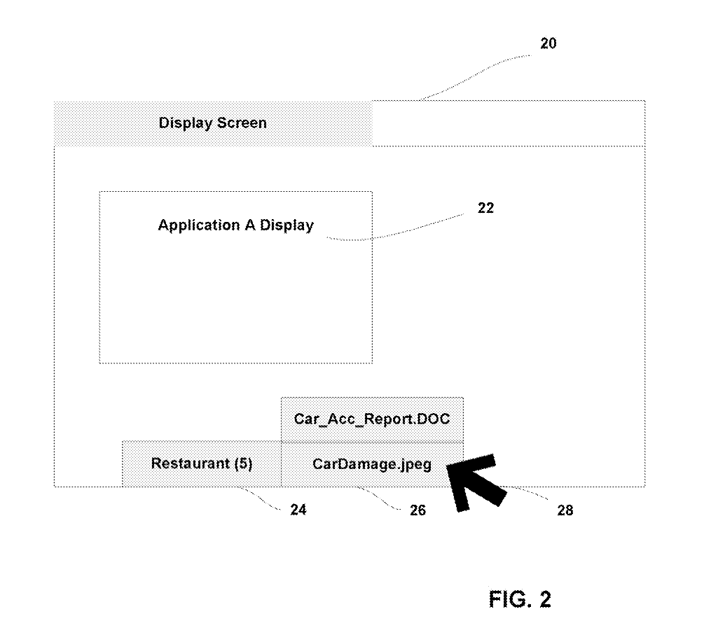

FIG. 2 illustrates an example display screen having a user interface according to an embodiment of the present invention. In FIG. 2, a display screen 20 has an application display 22, and minimized user interfaces having group names restaurants 24 and car 26. The user interface pointer 28 may click on the button representation of car and see a drop list of the two user interfaces represented, including an accident report document and a car damage picture.

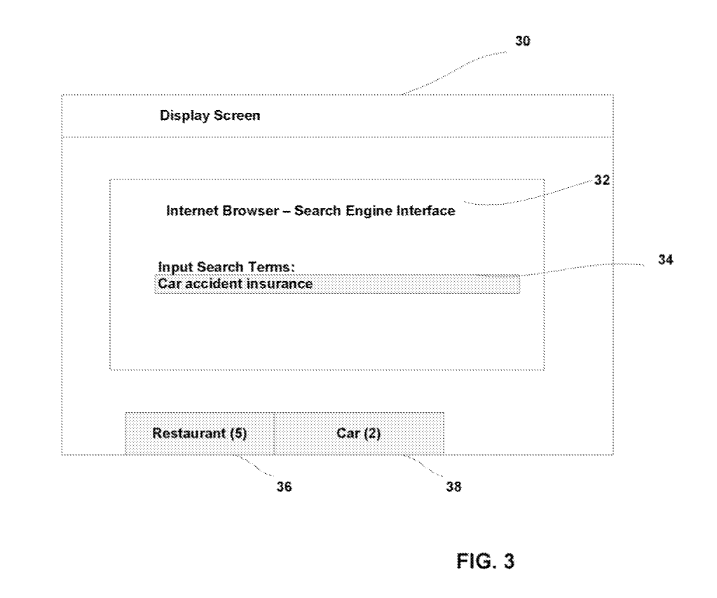

FIG. 3 illustrates an example display screen having a user interface according to an embodiment of the present invention. In FIG. 3, a display screen 30 has an internet browser search engine user interface 32. The search terms “car accident insurance” 34 may be copied and used to determine to what group the resulting opened pages belong—for example, if to restaurant 36 or car 38. Further, a lookup table may be used to determine the group based on the keyword used.

FIG. 4 illustrates an example lookup table for determining groupings of user interfaces according to an embodiment of the present invention. For example, a user may predefined some group names to assist in its interface organizations. For example, a group name 44 of car may apply to keywords 40 including car, accident, insurance, etc. In addition, a hierarchy may be established so that if a file contains more than one keyword (e.g., via search terms used, title of interface, inputted information), then a priority is scheduled to indicate as to what group name the user interface should most likely belong. For example, if a search is done via an internet browser on John's birthday food, then by the lookup table, the resulting group name should be “John-Birthday” not Restaurant, since “John” has a higher hierarchical rating of 1, and “food” has a hierarchical rating of “2.” This predefined table may be prepared and/or available via an online or networked source, a media, and a database on the system. The predefined table further may obtain input from an online dictionary, user, etc. The hierarchical rating may be inputted by the user, by alphabet (forward or reverse), random, etc.

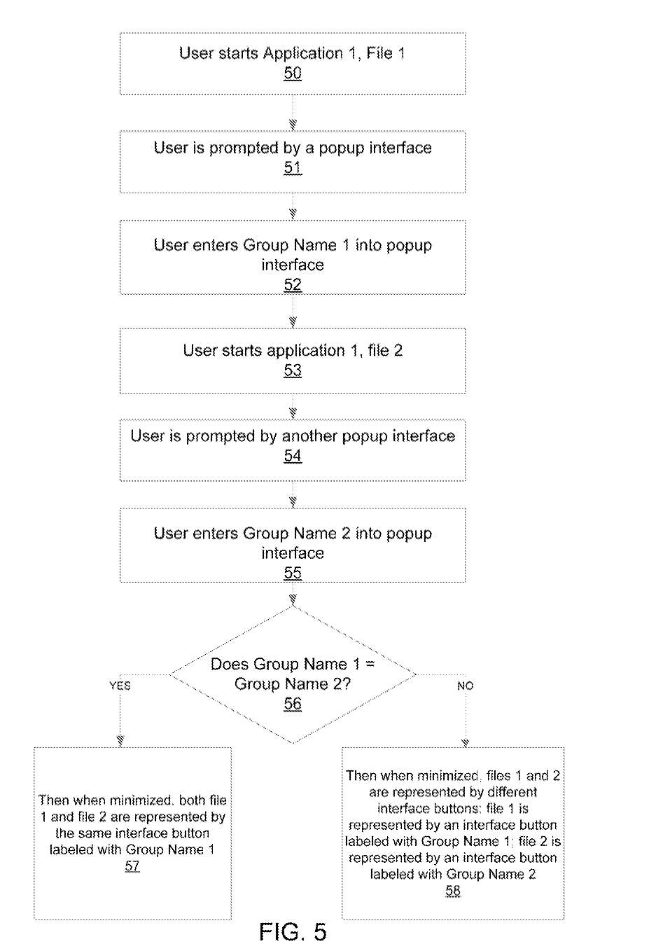

FIG. 5 is a flowchart involving multiple files of an application according to an embodiment of the present invention, in FIG. 5, a user starts a file of an application 50 which opens in a first user interface. A user may then be prompted by a popup window, email, or other electronic means to input a desired group name for the first user interface 51. The user then may enter the group name 52. The user may also start another file of the same application 53. Again, the user may be prompted for a group name 54. The user may enter a new group name, or the same group name entered for the first file 55. A differential analysis or compare is executed to determine whether the first and second were the same 56. If the group names were the same, then when the first and second user interfaces are minimized, they are both represented under the same interface button or other indicative mode (e.g., an icon, link, etc.) 57. The minimized representation button may include the group name. If the group names were not the same, a check may be done to see if they are similar (to account for typing errors et al.). Thus, if not the same, then the first and second files are assigned to different groups, and, when minimized, are represented by different group name buttons or other indicative mode 58.

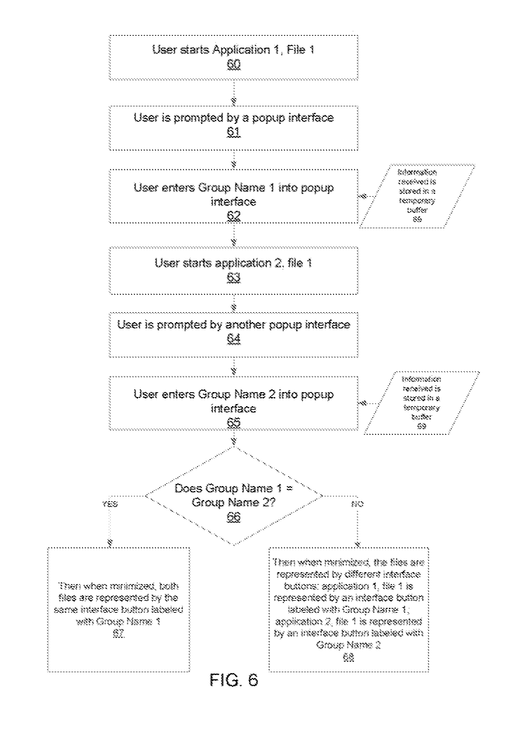

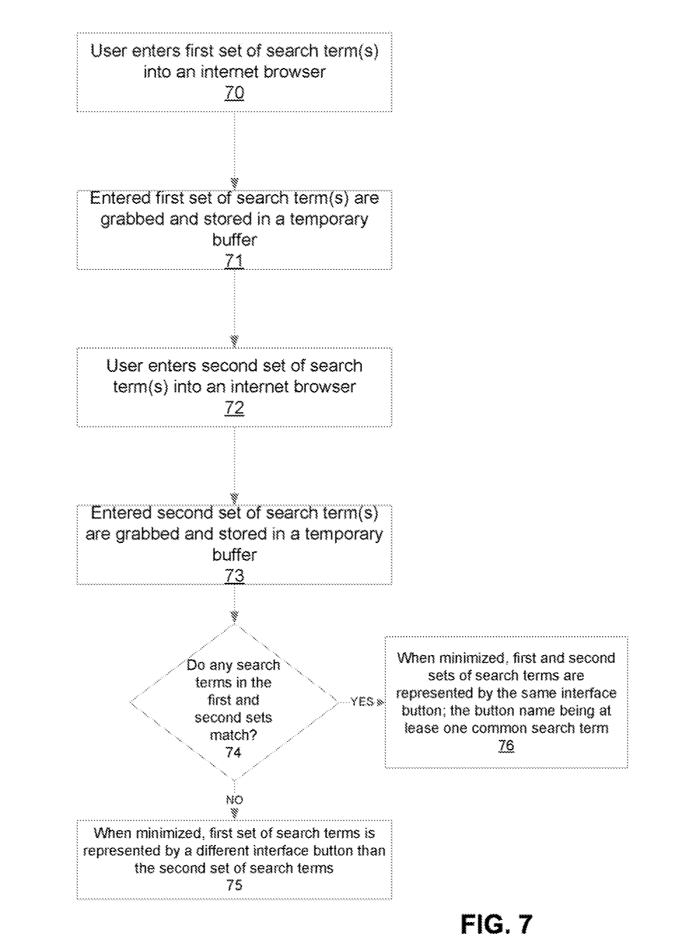

FIG. 6 is a flowchart involving multiple applications according to an embodiment of the present invention. In FIG. 6, a user may start a file in a first application 60. The user may be prompted by a popup interface or other mode to input a desired group name 61. Upon entering a group name 62, the information received may be stored in a temporary buffer 69. The user may also start a file in a different application 63. The user may be prompted by a popup interface or other mode to input a desired group name 64. Upon entering a group name 65 for the second interface, the information is stored in a temporary buffer 69. The temporary buffer(s) storing the first and second group names may be the same buffer, or may be different buffers. Further, information concerning the different groups may be stored on multiple databases. A differential analysis or compare may be done 66 on the two inputted group names to determine if they are the same, or similar. If the same, then the interfaces may both be represented under the same group name 67, even though the interfaces concern different applications. If not the same, then the interfaces will be represented under a different group name 68. FIG. 7 is a flowchart involving an application having a search engine according to an embodiment of the present invention, in FIG. 7, an example involving an Internet browser In provided. A user may enter a set of first search terms Into an internet browser 70. For example, a user may enter “German food Heidelberg restaurant”into the user interface of the internet browser's search engine. Before a search is even conducted, the search string may be copied into a temporary buffer or other location 71. Subsequently, a user may enter a second set of search term(s) into the internet browser 72. These search term(s) may also be copied into a temporary buffer or other location 73. The search term(s) from the first and second searches may be in the same buffer or different locations. A differential analysis of the search terms may then be conducted to see whether any of the search term(s) match 74. If no match is found 75, then the search term(s) sets are represented by different buttons (or the like). If a match is found 76, then the search term(s) sets may be represented by the same button (or the like), depending upon the arrangement of the system. That is, if a lookup table is available, it may provide a hierarchical status to different keywords and thus arrange which interfaces are represented by which group names.

Further, in the second search, a user may have entered “resterant food Germany.” A differential analysis may be configured to find the common match of “food.” A differential analysis may also be configured to find that “Germany” and “German” are similar. A differential analysis may also be configured to determine that “resterant” is not a word, and further that “resterant” is likely a misspelling of “restaurant.” In such situations, a user may be prompted via an alert In a popup interface or window, or may be sent an email to indicate the similarities. Or, a user may be prompted with a decision whether or not to consider the similar words as the same for grouping purposes.

Embodiments of the present invention may involve more than two user interfaces and/or two applications. Embodiments of the present invention may use temporary buffer(s), file(s) (e.g., notepad), database(s), etc. to store the keywords, search strings, user inputs, file/interface names, etc.

In embodiments of the present Invention, a computer network is suitable for use with the present invention. The network may include one or more computers and network servers interconnected via a network fabric. The computers may include processors, memory devices and input/output devices and may execute various program Instructions that manage their operation. Some program Instructions may define an operating system for the computer, while other program instructions may define various applications such as personal information managers, word processors, spreadsheet applications, browsers and enterprise resource management applications, among others. The window manager tool of the present invention may find use in various applications in which data is displayed in tabular format. As such, the window manager tool of the present invention may be represented by program instructions that are stored in the computers memory system.

Computers may be integrated into a larger network and provided in communication with servers. In such instances, the servers may execute applications and present data to the computers as part of their operations. In one embodiment, the computer and server may communicate via portal-based communication sessions. In this operation the view selection tool may be presented to a computer via a browser based interface. As such, the view selection tool may be represented by program instructions that are stored in the server's memory system.

While the invention has been described with reference to the above embodiments, it is to be understood that these embodiments are purely exemplary in nature. Thus the invention is not restricted to the particular forms shown in the foregoing embodiments. Various modifications and alterations can be made thereto without departing from the spirit and scope of the invention.

What is claimed is:

1. A method for organizing user interfaces, comprising;
opening a first user interface file of an application,
opening a second user interface file of the application,
recording in a first temporary buffer an information of the first user interface fie,
recording in a second temporary buffer an information of the second user interface file,
conducting a differential analysis of the first and second temporary buffers,
wherein if the differential analysis indicates no common term, then each file will have its own respective group name, and if the differential analysis indicates at least one common term, then the first and second files are appointed the same group name, and when minimized on a display screen, the first and second files are represented under their group name.

2. The method of claim 1, wherein the information of the first and second files is one of inputted search terms, first word of a title of the file, a title of the file, and an inputted term(s).

3. The method of claim 1, further comprising;
providing a listing of group names;
conducting a differential analysis with the first and second files, wherein if the differential analysis produces a match, then any files matching are listed under the group name of the groups listing.

4. The method of claim 3, wherein the groups listing is a pre-inputted list from the user.

5. The method of claim 3, wherein the groups listing is taken from an online resource.

6. The method of claim 1 wherein the group name is the common word found.

7. The method of claim 3, wherein the application of the first file is different from the application of the other file.

8. The method of claim 1 further comprising:
providing a user interface to the user to create a group name for the user interface and any related user interfaces.

9. A storage media for organizing user interfaces, comprising:
instructions for opening a first user interface file of an application,
instructions for opening a second user interface file of the application,
instructions for recording in a first temporary buffer an information of the first user interface file,
instructions for recording in a second temporary buffer an information of the second user interface file,
instructions for conducting a differential analysis of the first and second temporary buffers,
wherein if the differential analysis indicates no common term, then each file will have its own respective group name, and if the differential analysis indicates at least one common term, then the first and second files are appointed the same group name, and when minimized on a display screen, the first and second files are represented under their group name.

10. The media of claim 9, further comprising;
instructions for providing a listing of group names,
instructions for conducting a differential analysis with the first and second files, wherein if the differential analysis produces a match then any files matching are listed under the group name of the groups listing.

11. The method of claim 10, wherein the groups listing is a predefined table.
